(19) United States
(12) Patent Application Publication
(10) Pub. No.: US 2025/0300165 A1
(43) Pub. Date: Sep. 25, 2025

(54) FEEDING SYSTEM AND SYSTEM FOR MANUFACTURING ELECTRODE INCLUDING SAME

(71) Applicants: HYUNDAI MOTOR COMPANY, Seoul (KR); Kia Corporation, Seoul (KR)

(72) Inventors: Chan Bum Park, Suwon-si (KR); Hyun Jin Kim, Daegu (KR); Hyeon Ha Lee, Anyang-si (KR); Han Nah Song, Suwon-si (KR)

(73) Assignees: HYUNDAI MOTOR COMPANY, Seoul (KR); Kia Corporation, Seoul (KR)

(21) Appl. No.: 18/825,234

(22) Filed: Sep. 5, 2024

(30) Foreign Application Priority Data
Mar. 21, 2024 (KR) 10-2024-0038867

(51) Int. Cl. H01M 4/139; B65B 35/20; H01M 4/04

(52) U.S. Cl. CPC H01M 4/139; B65B 35/205; H01M 4/0419

(57) ABSTRACT

In the manufacture of a dry electrode, a feeding system includes a conveyor configured to distribute a material and to be rotatable, a pusher configured to move the material on the conveyor, and a guide configured to receive the material moved by the pusher and to guide movement of the material to a film forming device.

### CROSS-REFERENCE TO RELATED APPLICATION

The present application claims priority to Korean Patent Application No. 10-2024-0038867, filed on Mar. 21, 2024, the entire contents of which is incorporated herein for all purposes by this reference.

### BACKGROUND OF THE PRESENT DISCLOSURE

### Field of the Present Disclosure

The present disclosure relates to the manufacture of a dry electrode.

### Description of Related Art

Recently, application of rechargeable secondary batteries is expanding in various fields, from small electronic devices to large energy storage systems. In particular, thorough research and development into secondary batteries is ongoing due to rapid growth of the electric vehicle market.

Electrodes for secondary batteries have typically been manufactured through a wet process. In the wet process, a slurry is prepared by dissolving an electrode active material, a binder, and a conductive material, which are contained in the electrode, in a solvent. However, a dry process capable of increasing energy density of the battery compared to the wet process without using the solvent required in the wet process is receiving great attention in recent years.

In the dry electrode process, a dry electrode film is formed by mixing an electrode active material, a conductive material, and a binder without a solvent to form a mixture, which is then formed into a film by pressing or calendaring. Thereafter, the dry electrode film thus formed is attached to a current collector, completing manufacture of the electrode.

Compared to the wet electrode manufacturing process, the dry electrode manufacturing process does not use a solvent, which reduces the manufacturing time and cost and enables control of the thickness of a film to be formed, thereby obtaining a dry electrode film with high energy density.

Dry electrodes tend to easily agglomerate, so specially designed feeding technology is required when forming a film.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a feeding system configured for manufacturing a dry electrode having excellent and uniform quality and a system for manufacturing an electrode including the same.

The present disclosure is directed to providing a feeding system configured for preventing a bridging phenomenon which may occur when forming a dry electrode film, and a system for manufacturing an electrode including the same.

The present disclosure is directed to providing a feeding system configured for high-speed feeding and wide feeding of a dry electrode, and a system for manufacturing an electrode including the same.

The objects of the present disclosure are not limited to the foregoing, and other objects not mentioned herein will be able to be clearly understood through the following description by one having ordinary skill in the art to which the present disclosure belongs.

To accomplish the objects of the present disclosure described above and perform characteristic functions of the present disclosure described later, the features of the present disclosure are as follows.

According to various some embodiments of the present disclosure, a feeding system includes a conveyor configured to distribute a material and to be rotatable, a pusher configured to move the material on the conveyor, and a guide configured to receive the material moving by the pusher and to guide movement of the material to a film forming device.

According to various some embodiments of the present disclosure, a method of manufacturing an electrode includes supplying a dry electrode mixture to a roll press through a feeding system including a conveyor and forming the dry electrode mixture into a film by the roll press.

According to various some embodiments of the present disclosure, a system for manufacturing an electrode includes a roll press and a feeding system configured to supply a dry electrode mixture to the roll press. The feeding system may include a supplier configured to supply the dry electrode mixture, a conveyor configured to distribute the dry electrode mixture, a pusher configured to move the dry electrode mixture on the conveyor, a guide configured to receive the dry electrode mixture moving by the pusher and to guide movement of the dry electrode mixture to the roll press, and a controller configured to control operation of the roll press and the feeding system.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 schematically shows a process of manufacturing a dry electrode;

FIG. 2 is a conceptual view of a feeding system according to an embodiment of the present disclosure;

FIG. 3 is a perspective view of a feeding system according to an embodiment of the present disclosure;

FIG. 4 is an enlarged view of a supplier and a conveyor of the feeding system of FIG. 3;

FIG. 5 is an enlarged view of a pusher of the feeding system of FIG. 3;

FIG. 6 shows the pusher of FIG. 5;

FIG. 7 is an enlarged view of an inclination guide of the feeding system of FIG. 3;

FIG. 8A is an enlarged view of a guide of the feeding system of FIG. 3;

FIG. 8B is an enlarged view of the guide of the feeding system of FIG. 3;

FIG. 9 is an enlarged view of a sensor of the feeding system of FIG. 3;

FIG. 10 is a control flowchart of the feeding system according to an embodiment of the present disclosure; and

FIG. 11 is a control flowchart of the feeding system according to an embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Specific structural and functional descriptions of embodiments of the present disclosure are merely illustrative for the purpose of explaining the embodiments according to the concept of the present disclosure, and embodiments of the present disclosure may be implemented in various forms. Moreover, the present disclosure should not be construed as being limited to the embodiments described in the present specification, and should be understood to include all changes, equivalents, and substitutes included in the spirit and technical scope of the present disclosure.

Meanwhile, it will be understood that, although terms such as “first,” “second,” etc., may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element.

It will be understood that when an element is referred to as being “coupled” or “connected” to another element, it may be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between,” “directly between,” “adjacent to,” or “directly adjacent to,” should be construed in the same way.

Throughout the specification, the same reference numerals denote the same or like elements. Meanwhile, the terms used in the present specification are intended to describe the embodiments and are not intended to limit the present disclosure. As used herein, the singular forms are intended to include the plural forms as well, unless the context clearly indicates otherwise. It will be further understood that the terms “comprises” and/or “comprising” used herein specify the presence of stated elements, steps, operations, and/or devices, but do not preclude the presence or addition of other elements, steps, operations, and/or devices.

Hereinafter, a detailed description will be provided of the present disclosure with reference to the accompanying drawings.

A dry electrode may be manufactured from a dry electrode mixture and a current collector, without a solvent. The dry electrode mixture is a mixture including an electrode active material, a conductive material, and a binder.

The dry electrode may be a cathode or an anode. In some embodiments of the present disclosure, when a cathode is manufactured, the electrode active material includes a cathode active material. As a non-limiting example, the cathode active material may be nickel manganese cobalt (NMC), lithium ferrophosphate (LFP), lithium cobalt (LCO), or sulfur. In some embodiments of the present disclosure, when an anode is manufactured, the electrode active material includes an anode active material. For example, the anode active material may be graphite. In an embodiment of the present disclosure, the conductive material may include a carbon-based material. As a non-limiting example, the binder may include polytetrafluoroethylene (PTFE).

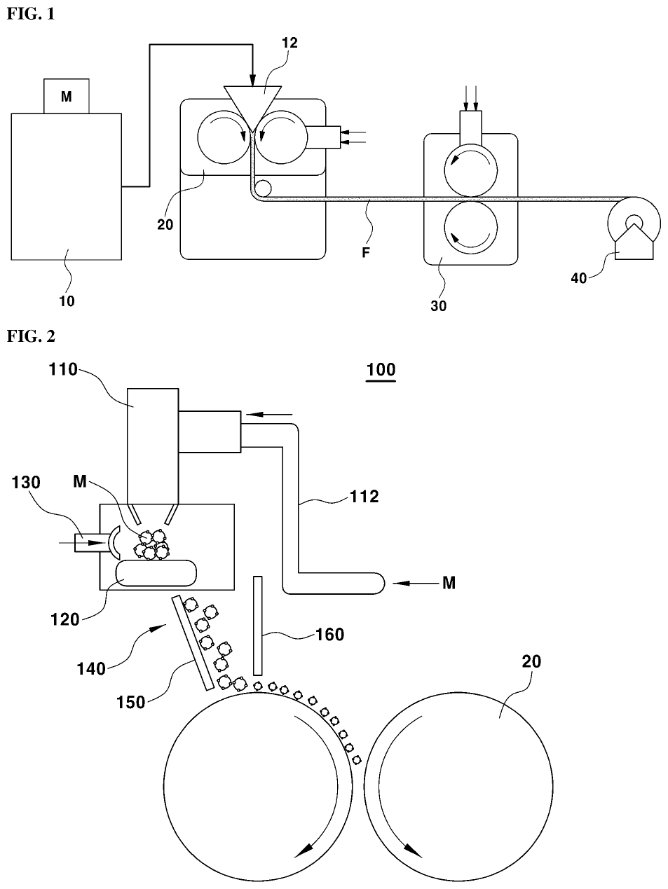

As shown in FIG. 1, a dry electrode mixture M, which is a powder, may be manufactured into a dry electrode film F through a series of film forming processes in which heat and pressure are applied. First, the dry electrode mixture M including the electrode active material, the conductive material, and the binder is mixed using a mixer 10 under conditions of predetermined time and speed.

The dry electrode mixture M mixed in the mixer 10 may be directed to a feeder 12, such as a hopper or a roll press 20. The dry electrode mixture M may be primarily pressed into a film by an upstream roll press 20. The upstream roll press 20 rotates while providing pressing force to form the dry electrode mixture M into a film. The dry electrode mixture M primarily formed into a film may be additionally pressed by a downstream roll press 30, and the thickness thereof may be adjusted through pressing. The dry electrode film F, which is formed from the dry electrode mixture, is wound by a winder 40. Then the dry electrode film F may be attached to or laminated on a current collector, manufacturing a dry electrode.

Dry electrodes for secondary batteries, unlike wet electrodes, are manufactured from a powder or a dry electrode mixture M, so they are difficult to handle. Therefore, as described above, specific feeding technology for dry electrodes is required. Dry electrode feeding technology must be able to prevent agglomeration or bridging that may occur due to the nature of powder. For example, when the dry electrode mixture is stored in a hopper for a long time, agglomeration may become severe, and the dry electrode mixture may not be supplied to the roll press 20. In addition, dry electrode feeding technology must be able to respond to properties of the powder that varies depending on processing conditions, such as temperature, humidity, feeding speed, feeding width, etc. Additionally, when the width of the dry electrode to be formed is changed under hopper feeding, the change should be manageable without major design changes.

The present disclosure relates to feeding technology for the dry electrode mixture M supplied to a film forming device or a roll press 20, which may solve the technical problems described above.

The feeding system 100 according to an exemplary embodiment of the present disclosure is configured to distribute the supplied dry electrode mixture widely in a width direction and supply the same to a roll press, enabling high-speed feeding and preparation of a wide dry electrode mixture. Also, the feeding system 100 may be freely programmed and controlled to meet conditions of the dry electrode mixture and requirements for the dry electrode to be manufactured (e.g., width of the dry electrode).

The feeding system 100 according to an embodiment of the present disclosure is configured for preventing a bridging phenomenon which may occur in the dry electrode mixture while guiding the dry electrode mixture to the roll press. A bridging phenomenon may be caused by agglomeration by pressure while the dry electrode mixture M is stacked in the feeder 12. This may prevent the dry electrode mixture from being supplied from the feeder 12 to the film forming device or the roll press, stopping the film forming process. According to an embodiment of the present disclosure, a bridging phenomenon may be prevented by adjusting the height of a guide configured to guide the dry electrode mixture. According to an embodiment of the present disclosure, the feeding system 100 is configured to prevent a bridging phenomenon by spraying air during movement of the dry electrode mixture.

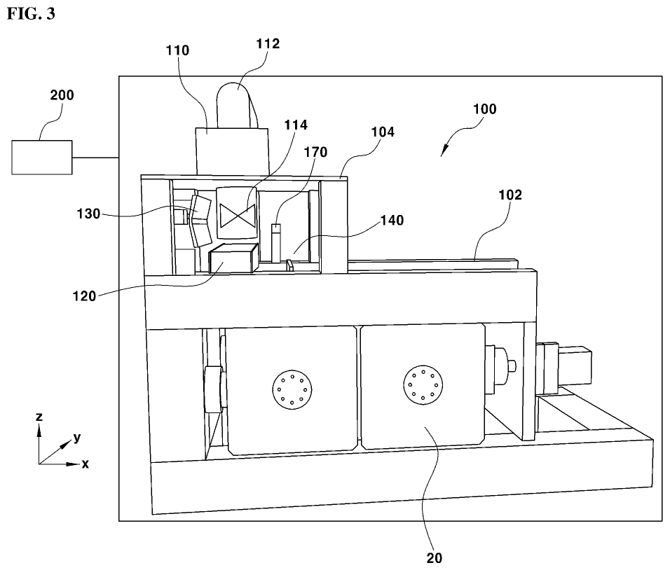

As shown in FIG. 2 and FIG. 3, according to an exemplary embodiment of the present disclosure, the dry electrode mixture M may be supplied to a film forming device or an upstream roll press (hereinafter, referred to as a roll press) through the feeding system 100. The supplied dry electrode mixture M may be manufactured in a form of a film by the roll press 20.

According to an embodiment of the present disclosure, the feeding system 100 may include a supplier 110, a conveyor 120, a pusher 130, and a guide 140. For example, the supplier 110, the conveyor 120, the pusher 130, and the guide 140 may be disposed in a frame 102.

In an embodiment of the present disclosure, operation of the feeding system 100 may be controlled by a controller 200. The controller 200 may communicate with each component of the feeding system 100 and control operation of each component based on collected information.

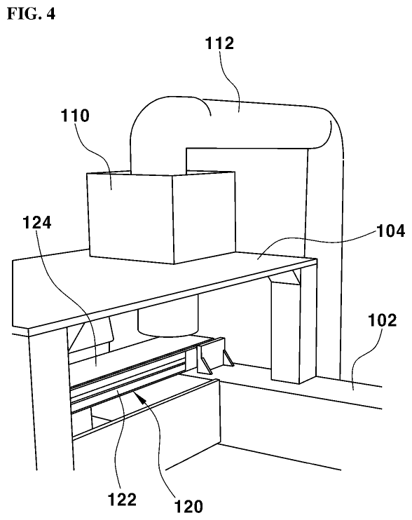

Referring to FIG. 4, the supplier 110 is configured to supply the dry electrode mixture M to the feeding system 100. For instance, the dry electrode mixture M in a tank or a mixer 10 in which the dry electrode mixture M is stored may be transported by the supplier 110. For example, the dry electrode mixture M may be vacuum-transported. In an example, the supplier 110 may be a vacuum transporter, and the dry electrode mixture M may be vacuum-transported through a pipe 112.

The conveyor 120 is configured to receive the dry electrode mixture M from the supplier 110. The supplied dry electrode mixture M may be widely distributed on the conveyor 120. The supplied dry electrode mixture M may be evenly distributed on the conveyor 120. The feeding system 100 according to an embodiment of the present disclosure is configured to distribute the supplied dry electrode mixture widely in the width direction of the conveyor 120 and to supply the same to the roll press 20, enabling high-speed feeding and preparation of a wide dry electrode mixture.

The dry electrode mixture M may be selectively discharged from the supplier 110. In an embodiment, the dry electrode mixture M may be continuously supplied to the conveyor 120 by the supplier 110. In another embodiment, the dry electrode mixture M may be intermittently supplied to the conveyor 120 by the supplier 110.

The supplier 110 includes a controllable valve 114 including an actuator. The valve 114 may be controlled by the controller 200 of the feeding system 100, in which the controller 200 is operably connected to the actuator of the controllable valve 114. Based on the opening time of the valve 114, the dry electrode mixture M may be continuously or intermittently distributed on the conveyor 120.

According to an embodiment of the present disclosure, the conveyor 120 includes a fixed portion 122 and a rotation portion 124. The rotation portion 124 may rotate relative to the fixed portion 122. The rotation portion 124 may be operably connected to the controller 200, and operation of the rotation portion 124 may also be controlled by the controller 20. For example, the conveyor 120 may be a belt conveyor. In an embodiment, the dry electrode mixture M may be disposed at an interval on the rotation portion 124 in the width direction (y-axis direction) depending on the opening time of the valve 114 during rotation of the rotation portion 124. In another embodiment, the dry electrode mixture M may be continuously disposed on the rotation portion 124 in the width direction (y-axis direction) along the rotation portion 124 depending on the opening time of the valve 114 during rotation of the rotation portion 124.

In some embodiments of the present disclosure, the conveyor 120 may be fixed and the supplier 110 may move in the y-axis direction of the conveyor 120 so that the dry electrode mixture M may be distributed at a predetermined interval on the conveyor 120.

In an embodiment, a protective plate 104 may be disposed between the supplier 110 and the conveyor 120. The protective plate 104 is configured to prevent foreign substances other than the dry electrode mixture M supplied from the supplier 110 from falling on the conveyor 120. In some embodiments, the frame 102 surrounding the conveyor 120 may be configured to be housed to prevent the introduction of foreign substances.

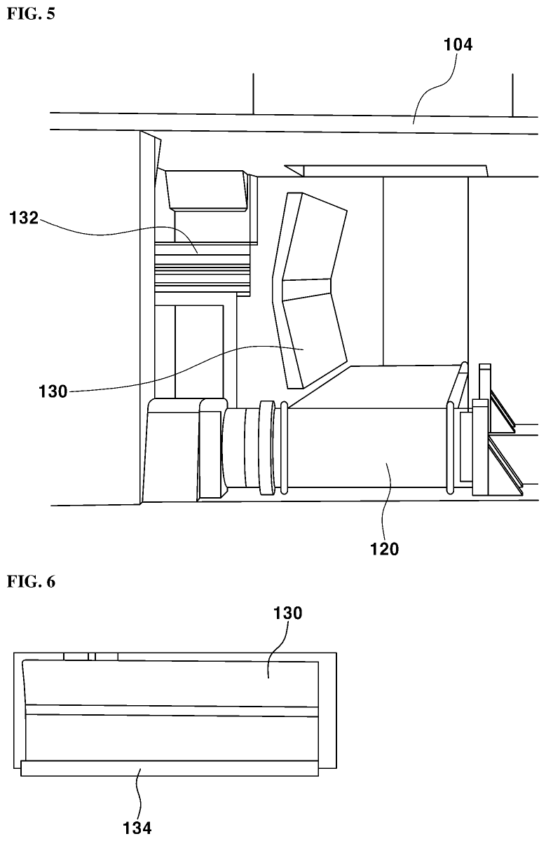

As shown in FIG. 5, the pusher 130 is configured to direct the dry electrode mixture M distributed on the conveyor 120 toward the roll press 20. In an embodiment, the pusher 130 is disposed at one side of the conveyor 120 and configured to push the dry electrode mixture M placed on the conveyor 120 toward the outside of the conveyor 120. The dry electrode mixture M may be pushed from the conveyor 120 toward the roll press 20 by the pusher 130.

The pusher 130 may operate by an actuator operably connected to the controller 200. For example, the pusher 130 may move forward or backward in the x-axis direction toward the conveyor 120 by an electric cylinder 132 operably connected to the controller 200. Herein, other known actuators may be used in place of the electric cylinder 132.

As shown in FIG. 6, the pusher 130 may include a brush 134. The brush 134 may be mounted on the bottom portion of the pusher 130. The brush 134 is configured to prevent the dry electrode mixture M from remaining on the conveyor 120 when the pusher 130 operates.

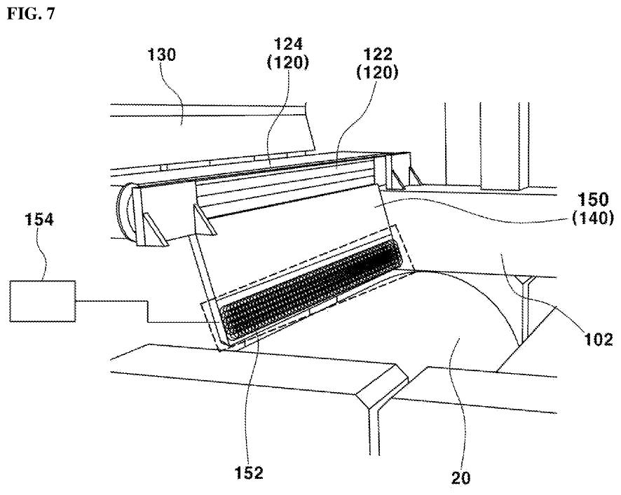

Referring to FIG. 7, the guide 140 is configured to guide movement of the dry electrode mixture M from the conveyor 120 to the pressing point of the roll press 20. The dry electrode mixture M may be supplied to the roll press 20 while the flow of the dry electrode mixture M is adjusted through the guide 140 before the dry electrode mixture M is pressed by the roll press 20. According to an embodiment of the present disclosure, the guide 140 may include at least one of an inclined guide 150 or a vertical guide 160.

The inclined guide 150 may be disposed adjacent to the conveyor 120. For example, the inclined guide 150 may be supported with respect to the fixed portion 122 of the conveyor 120. The inclined guide 150 may also be disposed above the roll press 20. The inclined guide 150 may be disposed above any one of two rolls forming the roll press 20.

The inclined guide 150 is disposed at a predetermined angle with respect to the z-axis direction (vertical direction). In an embodiment, the angle of the inclined guide 150 may be adjusted. The angle of the inclined guide 150 with respect to the z-axis may be adjusted depending on properties of the dry electrode mixture M.

The dry electrode mixture M supplied from the conveyor 120 may be guided along the inclined guide 150 disposed obliquely. As a non-limiting example, a material for the inclined guide 150 may include a low friction resin-based material.

The inclined guide 150 includes a plurality of supply holes 152. The supply holes 152 may be formed in the inclined guide 150 in multiple rows and columns, and may be formed in the lower portion of the inclined guide 150.

Air may be supplied through the supply holes 152. Air through the supply holes 152 may be supplied by an air supply device 154 configured to be in fluid communication with the supply holes 152. Supply of air through the supply holes 152 may, prevent agglomeration or bridging which may occur in the dry electrode mixture M.

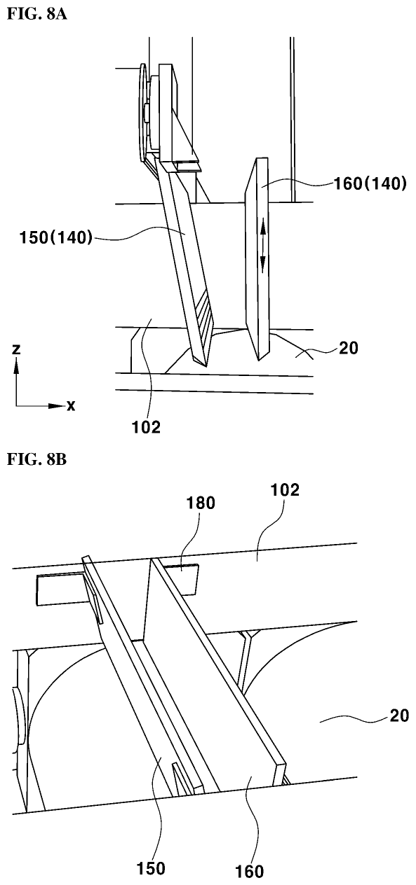

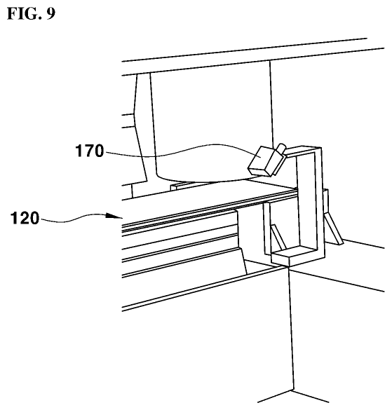

Referring to FIG. 8A, the vertical guide 160 is disposed adjacent to the inclined guide 150. As shown in FIG. 8B, in one embodiment, the inclined guide 150 and the vertical guide 160 may be supported by the frame 102. In some embodiments, the inclined guide 150 and the vertical guide 160 may be supported by the frame 102 via brackets 180.

The vertical guide 160 may be disposed above the roll press 20 while being spaced apart from the inclined guide 150 at a predetermined interval. The vertical guide 160 may be disposed above any one of the two rolls forming the roll press 20.

The vertical guide 160 is disposed to be movable upward and downward. In one embodiment, the vertical guide 160 may be disposed to be movable upward and downward or along the z-axis with respect to the frame 102. For example, the vertical guide 160 may be disposed to be movable upwards and downwards by an actuator operably connected to the controller 200, such as an electric cylinder or a linear guide, which is merely exemplary, and may be configured to be movable using other known devices.

The vertical guide 160 may adjust the amount of the dry electrode mixture M introduced into the feeding zone of the roll press 20 through up and down movement of the vertical guide 160. Accordingly, the dry electrode mixture M may be constantly supplied on the roll press 20. By adjusting the position of the vertical guide 160, the dry electrode mixture M may be supplied through a predetermined interval between the vertical guide 160 and the roll press 20.

The height of the vertical guide 160 may be controlled by the controller 200. For example, the controller 200 may change the position of the vertical guide 160 by operation of the actuator depending on the amount of the dry electrode mixture M which is introduced.

As shown in FIG. 9, the feeding system 100 may include a sensor 170. The sensor 170 may be supported by the frame 102. In one embodiment of the present disclosure, the sensor 170 may detect the amount or height of the dry electrode mixture M placed on the roll press 20. In an exemplary embodiment of the present disclosure, the amount or height of the dry electrode mixture M on the conveyor 120 may be detected by the sensor 170.

The sensor 170 is configured to communicate with the controller 200 communicatively connected to the sensor 170. Information related to the amount or height of the dry electrode mixture M detected by the sensor 170 may be transmitted to the controller 200. In the controller 200, the relevant information may be used as a basis for determination for controlling the height of the vertical guide 160 or the moving speed of the conveyor 120.

The controller 200 may include at least one controller. The controller 200 may be a controller that is integrated with a controller for a dry electrode manufacturing process or may be a controller that is separately provided to control the feeding system 100.

As described above, the controller 200 may supervise and control operation of each component of the feeding system 100. In an embodiment, operation of the supplier 110 including the valve 114 may be controlled by the controller 200. In an embodiment, operation of the conveyor 120 may be controlled by the controller 200. In an embodiment, the controller 200 may control operation of the electric cylinder 132 to actuate the pusher 130. In an embodiment, operation of the air supply device 154 may be controlled by the controller 200. In an embodiment of, the position of the vertical guide 160 may be controlled by the controller 200. In an embodiment, detection information of the sensor 170 may be collected by the controller 200.

The controller 200 includes a processor and memory. The memory includes a series of instructions executable by the processor, and the processor is configured to execute instructions stored in the memory. For example, depending on the instructions, operation of each component of the feeding system 100 may be controlled by the controller 200.

According to an embodiment of the present disclosure, operation of the feeding system 100 will be described as follows.

The dry electrode mixture M is transported by the supplier 110, such as a vacuum transporter. When the valve 114 is opened by the controller 200 based on the set time, the dry electrode mixture M is supplied to the conveyor 120. As the conveyor 120 is actuated, the dry electrode mixture M may be distributed in the moving direction of the conveyor 120 or the y-axis direction thereof. For example, when the dry electrode mixture M is intermittently distributed by the supplier 110, the controller may control the conveyor 120 in such a way that the conveyor 120 stops when the dry electrode mixture M is supplied and moves a predetermined distance after completion of the supply. The number of repetitions of stopping and moving may be determined depending on the width of a dry electrode to be manufactured.

When distribution of the dry electrode mixture M on the conveyor 120 is completed, the pusher 130 is actuated by the controller 200. The dry electrode mixture M on the conveyor 120 may be directed toward the roll press 20 by forward movement of the pusher 130. Dry electrode mixture M remaining on the conveyor 120 may be brushed off by the brush 134 of the pusher 130.

When the pusher 130 is actuated, the dry electrode mixture M moves onto the roll press 20 along the inclined guide 150. Here, air may be sprayed through the supply holes 152 by actuating the air supply device 154 by the controller 200, which may prevent agglomeration of the dry electrode mixture M and enables efficient film formation by the roll press 20.

As the roll press 20 rotates, the dry electrode mixture M placed on the roll press 20 passes through the vertical guide 160 and moves to the pressing point of the roll press 20. The dry electrode mixture M in an amount determined by the interval between the vertical guide 160 and the roll press 20 formed depending on the height adjustment of the vertical guide 160 may be supplied to the pressing point of the roll press 20.

A predetermined amount of the dry electrode mixture M supplied to the pressing point may be manufactured into a dry electrode in a form of a sheet through the roll press 20.

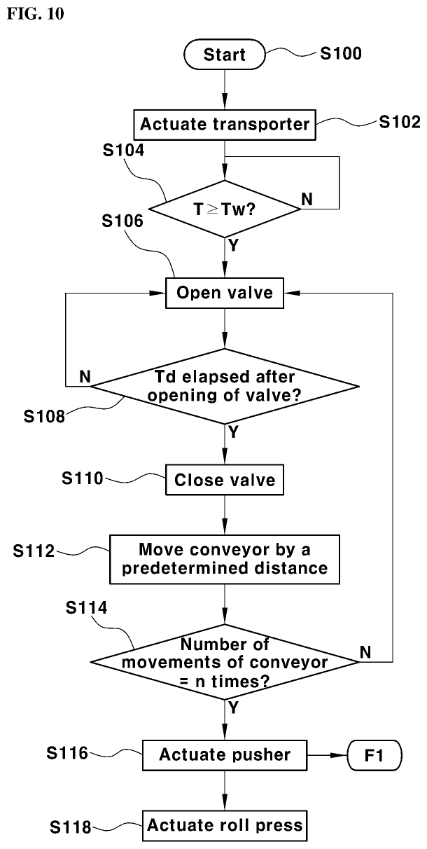

Referring to FIG. 10, operation of the feeding system 100 according to an embodiment of the present disclosure is described. The embodiment relates to control when the dry electrode mixture M is supplied intermittently or at a predetermined time interval from the supplier 110.

At S100, operation of the feeding system 100 for manufacturing a dry electrode starts.

At S102, the vacuum transporter or the supplier 110 is actuated by the controller 200. The supplier 110 is configured to draw the dry electrode mixture M in the tank or the mixer 10 for a predetermined time in a vacuum transport manner.

At S104, the controller 200 is configured to determine whether the elapsed time T after operation of the supplier 110 is equal to or longer than a predetermined waiting time Tw. The waiting time Tw may be predetermined based on delivery time of the dry electrode mixture M through the pipe 112.

When the controller concludes that the waiting time Tw has elapsed, the valve 114 is opened by the controller 200 at S106. The controller 200 is configured to determine whether the operating time Td has elapsed after opening of the valve 114 at S108. The operating time Td may be the time required to distribute a predetermined amount of the dry electrode mixture M by the supplier 110.

If the controller concludes at S110 that the operating time Td has elapsed after opening of the valve 114, the controller 200 closes the valve 114.

When the valve 114 is closed, the conveyor 120 is actuated by the controller 200 at S112. The controller 200 operates the conveyor 120 so that the conveyor 120 moves a predetermined distance. Accordingly, the dry electrode mixture M distributed by the supplier 110 may be provided at a predetermined interval on the conveyor 120.

At S114, the controller 200 is configured to determine whether the number of movements of the conveyor 120 has reached the final number (n times). For each cycle, the controller 200 is configured to detect the number of movements of the conveyor 120. The number of movements may be determined based on the width of the dry electrode to be manufactured. For example, when the number of movements which may satisfy the width of the dry electrode is 10, the controller 200 may compare the current number of movements of the conveyor 120 with 10 movements.

If the number of movements of the conveyor 120 in the present cycle does not reach the final number (n times), the procedure is returned to S106, and opening and closing of the valve 114 are repeated by the controller 200.

When the number of movements of the conveyor 120 in the present cycle reaches the final number (n times), the pusher 130 is actuated by the controller 200 at S116. The dry electrode mixture M on the conveyor 120 may be moved to the roll press 20 by actuating the pusher 130, and the dry electrode mixture M may be formed into a film by rotating the roll press 20.

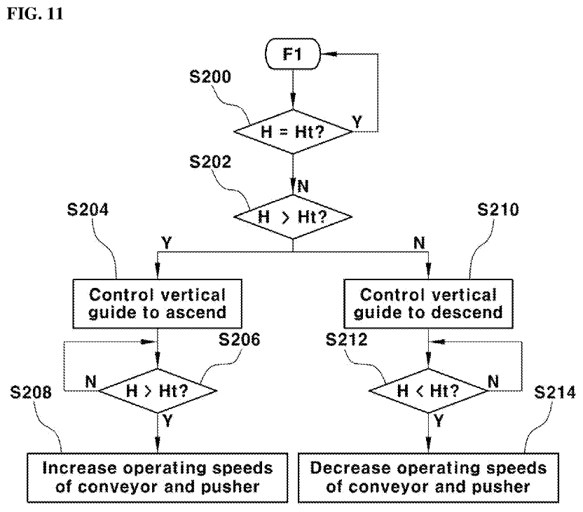

The flowchart according to FIG. 11 may be performed after F1 in FIG. 10. The embodiment of FIG. 11 relates to control of the vertical guide 160 when the dry electrode mixture M placed on the roll press 20 by the pusher 130 passes through the vertical guide 160.

At S200, the controller 200 receives information related to the height of the dry electrode mixture M from the sensor 170 in real time. The controller 200 is configured to determine whether the current height H of the dry electrode mixture M on the roll press 20 is a predetermined reference height Ht based on the received information. The reference height Ht may be defined as a height appropriate for or corresponding to the current height of the vertical guide 160.

If the controller concludes that the current height H is equal to the reference height Ht, the current height of the vertical guide 160 is maintained without any operation by the controller 200.

If the controller concludes that the current height H is not equal to the reference height Ht, the controller 200 is configured to determine whether the current height H is greater or less than the reference height Ht at S202.

If the controller concludes at S204 that the current height H of the dry electrode mixture M on the roll press 20 is greater than the reference height Ht, the vertical guide 160 is controlled to ascend by the controller 200. Then whether the current height H is greater than the reference height Ht is determined again by the controller 200 at S206. If the controller concludes that the current height H is still greater than the reference height Ht, the controller 200 is configured to perform control to increase the rotation speed of the conveyor 120 and the operating speed of the pusher 130 at S208.

Conversely, If the controller concludes that the current height H of the dry electrode mixture M on the roll press 20 at S202 is less than the reference height Ht, the vertical guide 160 is controlled to descend by the controller 200 at S210. Subsequently, the controller 200 is configured to determine again whether the current height H is less than the reference height Ht at S212. If the controller concludes that the current height H is still less than the reference height Ht, operating speeds of the conveyor 120 and the pusher 130 are reduced by the controller 200 at S214.

According to some embodiments of the present disclosure, the system for manufacturing a dry electrode may include the feeding system 100.

In the present specification, the feeding system 100 is only described as being used for the dry electrode mixture M, but the present disclosure may be applied to film formation using other types of powder in which agglomeration occurs due to the nature of the powder.

According to the present disclosure, a feeding system configured for forming a wide dry electrode film and a system for manufacturing a dry electrode including the same are provided.

According to he present disclosure, it is possible to speed up the film forming process by adjusting the amount of the dry electrode mixture introduced into the film forming process.

According to the present disclosure, the height of the vertical guide may be adjusted depending on the height of the dry electrode mixture placed on the roll press and air may be sprayed when moving the dry electrode mixture, preventing agglomeration of the dry electrode mixture and preventing interruption of the film forming process.

According to an the present disclosure, operation may efficiently proceed by changing processing conditions, such as the speed of the conveyor, the speed of the pusher, the speed of air spray, the position of the vertical guide, and the like depending on the material of the powder.

As is apparent from the above description, according to the present disclosure, a feeding system configured for manufacturing a dry electrode having excellent and uniform quality and a system for manufacturing an electrode including the same are provided.

According to the present disclosure, a feeding system configured for preventing a bridging phenomenon that occurs when forming a dry electrode film and a system for manufacturing an electrode including the same are provided.

According to an the present disclosure, a feeding system configured for high-speed feeding and large-width feeding of a dry electrode and a system for manufacturing an electrode including the same are provided.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operably may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A feeding system, comprising:
a conveyor configured to rotate, wherein a material is dispensed on the conveyor;
a pusher configured to move the material on the conveyor; and
a guide configured to receive the material moved by the pusher and to guide movement of the material to a film forming device.

2. The feeding system of claim 1, further comprising a supplier configured to supply the material to the conveyor.

3. The feeding system of claim 2, wherein the supplier is a vacuum transporter.

4. The feeding system of claim 1, wherein the guide comprises an inclined guide disposed at a predetermined angle with respect to the conveyor and disposed above the film forming device.

5. The feeding system of claim 4, wherein the inclined guide comprises a plurality of supply holes configured to spray air therethrough.

6. The feeding system of claim 4,
wherein the guide further comprises a vertical guide disposed above the film forming device and spaced apart from the inclined guide, and
wherein the vertical guide is adjustable in height with respect to the film forming device.

7. The feeding system of claim 1, wherein the pusher comprises a brush.

8. The feeding system of claim 1, further comprising:
a sensor configured to detect a height of the material on the conveyor or the film forming device; and
a controller operably connected to the conveyor, the pusher, the guide and the sensor and configured to control at least one of a speed of the conveyor, a speed of the pusher, or a position of the guide, based on the detected height.

9. The feeding system of claim 1, wherein the material is a dry electrode mixture comprising an electrode active material, a conductive material, and a binder.

10. A method of manufacturing an electrode, the method comprising:
supplying a dry electrode mixture to a roll press through a feeding system including a conveyor; and
forming the dry electrode mixture into a film by the roll press.

11. The method of claim 10, wherein supplying of the dry electrode mixture includes:
dispensing the dry electrode mixture on the conveyor by a supplier; and
directing the dry electrode mixture on the conveyor to the roll press by a pusher.

12. The method of claim 11, wherein directing of the dry electrode mixture to the roll press includes guiding the dry electrode mixture moved by the pusher onto the roll press by an inclined guide.

13. The method of claim 12, further comprising directing the dry electrode mixture to the roll press through a vertical guide to adjust a height of the guided dry electrode mixture.

14. The method of claim 10, further comprising:
passing the dry electrode mixture in a form of the film through a downstream roll press; and
winding, by a winder, the dry electrode mixture having passed through the downstream roll press.

15. A dry electrode manufactured by the method of claim 10.

16. A system of manufacturing an electrode, the system comprising:
a roll press; and
a feeding system configured to supply a dry electrode mixture to the roll press, the feeding system including:
a supplier configured to supply the dry electrode mixture;
a conveyor, wherein the dry electrode mixture supplied from the supplier is distributed on the conveyor;
a pusher configured to move the dry electrode mixture on the conveyor;
a guide configured to receive the dry electrode mixture moved by the pusher and to guide movement of the dry electrode mixture to the roll press; and
a controller operably connected to the roll press and the feeding system and configured to control operation of the roll press and the feeding system.

17. The system of claim 16, wherein the supplier includes a valve operably connected to the controller and controlled by the controller and configured to allow or block supply of the dry electrode mixture.

18. The system of claim 17, wherein the controller is further configured to control operation of at least one of the valve or the conveyor such that the dry electrode mixture is disposed at a predetermined interval on the conveyor.

19. The system of claim 16, further comprising a sensor operably connected to the controller and configured to detect a height of the dry electrode mixture moved to the roll press and to transmit detected information to the controller,
wherein the controller is further configured to adjust a height of the guide based on the detected information.

20. The system of claim 19, wherein the controller is further configured to adjust a speed of the conveyor and a speed of the pusher based on the detected information.
